(19) United States
(12) Patent Application Publication
(10) Pub. No.: US 2021/0042622 A1
(43) Pub. Date: Feb. 11, 2021

(54) SYSTEMS AND METHODS FOR PROVIDING A TRAVELLING SUGGESTION

(71) Applicant: BEIJING DIDI INFINITY TECHNOLOGY AND DEVELOPMENT CO., LTD., Beijing (CN)

(72) Inventor: Shujuan SUN, Beijing (CN)

(73) Assignee: BEIJING DIDI INFINITY TECHNOLOGY AND DEVELOPMENT CO., LTD., Beijing (CN)

(21) Appl. No.: 17/076,862

(22) Filed: Oct. 22, 2020

Related U.S. Application Data
(63) Continuation of application No. PCT/CN2018/087775, filed on May 22, 2018.

(51) Int. Cl. G06N 3/08; G06Q 50/30; G06Q 10/04; G06N 3/04; G01C 21/34

(52) U.S. Cl. CPC G06N 3/08; G06Q 50/30; G01C 21/3446; G06N 3/0454; G06Q 10/047

(57) ABSTRACT

Systems and methods for providing a travelling suggestion to an interface on a user terminal in an online on-demand transportation service are provided. A method includes: receiving a service request from a user terminal; obtaining a prediction model combining at least one Generative Adversarial Networks (GAN) and at least one Restricted Boltzmann Machines (RBM); determining at least one recommended route for the user terminal based on the service request and the prediction model; generating electronic signals including the recommended route and a triggering code; and sending the electronic signals to at least one antenna to direct the antenna to send the electronic signals to the user terminal, wherein the triggering code is: in a format recognizable by an operation system of the user terminal, and configured to render the operation system of the user terminal to generate a presentation of the recommended route on an interface of the user terminal.

### CROSS-REFERENCE TO THE RELATED APPLICATIONS

This application is a continuation of International Application No. PCT/CN2018/087775, filed on May 22, 2018, the contents of which are hereby incorporated by reference.

### TECHNICAL FIELD

The present disclosure generally relates to systems and methods for using artificial intelligence to determine and display a driving instruction to a user mobile device.

### BACKGROUND

In modern society, automobiles are becoming increasingly widespread with the rapid economic growth, which imposes heavy pressures on urban traffic and causes severe traffic jams. In the meantime, transportation utilizing Internet technology, such as online navigation services, have become increasingly popular because of their convenience. Travelling suggestions to guide users to travel along optimal routes with less congestions may improve user experiences and mitigate traffic congestions. However, it is hard to provide optimal travelling suggestions since the accurate prediction of traffic condition is difficult. With artificial intelligence using new trained model, this technical problem may be resolved.

### SUMMARY

An aspect of the present disclosure introduces a system of one or more electronic devices that uses artificial intelligence prediction model to determine a navigation route for a driver, and then render the driver's mobile phone to display driving instructions of the navigation route. The prediction model includes a stack of Generative Adversarial Networks (GAN) and Restricted Boltzmann Machines (RBM). According to different embodiments, the prediction model may use various combinations of the GAN and RBM.

In some embodiments, to obtain the prediction model, the at least one processor is further directed to: obtain training samples including road information associated with a plurality of roads; obtain at least one feature set from the training samples; and obtain the prediction model by training a hybrid model, wherein the hybrid model is a combination of at least one GAN and at least one RBM, and the training samples and the at least one feature set are inputs of the hybrid model.

In some embodiments, the at least one feature set includes a plurality of basic features, a plurality of real-time features, and a plurality of historical features.

In some embodiments, the at least one processor is further directed to: obtain a testing sample, wherein the testing sample includes road information associated with a plurality of roads; determine an accuracy rate of the prediction model based on the testing sample, wherein the testing sample is an input of the prediction model; determine that the accuracy rate is greater than an accuracy rate threshold; and obtain the prediction model.

In some embodiments, the at least one processor is further directed to: in response to determining that the accuracy rate is not greater than the accuracy rate threshold; and revise the prediction model.

In some embodiments, to determine the at least one recommended route, the at least one processor is further directed to: determine at least one possible driving route based on the service request; obtain at least one feature set associated with the at least one possible driving route; for each possible driving route, determine an estimated driving speed based on the prediction model and the at least one feature set associated with each possible driving route, wherein the at least one feature set is an input of the prediction model, and the estimated driving speed is an output of the prediction model; and determine at least one recommended route from the at least one possible driving route based on the estimated driving speed of each possible driving route.

In some embodiments, to determine the at least one recommended route, the at least one processor is further directed to: determine an estimated driving distance of each of the at least one possible driving route; for each of the at least one possible driving route, determine an estimated driving time based on the estimated speed and the estimated driving distance of each of the at least one possible driving route; and determine the at least one recommended route from the at least one possible driving route based on the estimated driving time of each possible driving route.

In some embodiments, the prediction model includes at least two layers: each layer includes at least one GAN or at least one RBM, and an output of a previous layer is an input of a next layer of the previous layer.

In some embodiments, the prediction model includes: a first layer including a GAN; a second layer including a RBM; and a third layer including a RBM.

According to another aspect of the present disclosure, a method for providing a travelling suggestion to an interface on a user terminal in an online on-demand transportation service may be implemented on one or more electronic devices having at least one antenna to receive a service request from a user terminal through wireless communications between the antenna and the user terminal, at least one computer-readable storage medium including a first operation system and a set of instructions compatible with the first operation system for providing a travelling suggestion to a user terminal in an online on-demand service, and at least one processor in communication with the storage medium. The method may include one or more following operations: receiving a service request from a user terminal; obtaining a prediction model combining at least one Generative Adversarial Networks (GAN) and at least one Restricted Boltzmann Machines (RBM); determining at least one recommended route for the user terminal based on the service request and the prediction model; generating electronic signals including the recommended route and a triggering code, wherein the triggering code is: in a format recognizable by a second operation system of the user terminal, and configured to render the second operation system of the user terminal to generate a presentation of the recommended route on an interface of the user terminal; and sending the electronic signals to the at least one antenna to direct the antenna to send the electronic signals to the user terminal.

In some embodiments, the obtaining the prediction model includes: obtaining training samples including road information associated with a plurality of roads; obtaining at least one feature set from the training samples; and obtaining the prediction model by training a hybrid model, wherein the hybrid model is a combination of at least one GAN and at least one RBM, and the training samples and the at least one feature set are inputs of the hybrid model.

In some embodiments, the at least one feature set includes a plurality of basic features, a plurality of real-time features, and a plurality of historical features.

In some embodiments, the method may further include one or more following operations: obtaining a testing sample, wherein the testing sample includes road information associated with a plurality of roads; determining an accuracy rate of the prediction model based on the testing sample, wherein the testing sample is an input of the prediction model; determining that the accuracy rate is greater than an accuracy rate threshold; and obtaining the prediction model.

In some embodiments, the method may further include one or more following operations: in response to determining that the accuracy rate is not greater than the accuracy rate threshold; and revising the prediction model.

In some embodiments, the determining the at least one recommended route include: determining at least one possible driving route based on the service request; obtaining at least one feature set associated with the at least one possible driving route; for each possible driving route, determining an estimated driving speed based on the prediction model and the at least one feature set associated with each possible driving route, wherein the at least one feature set is an input of the prediction model, and the estimated driving speed is an output of the prediction model; and determining at least one recommended route from the at least one possible driving route based on the estimated driving speed of each possible driving route.

In some embodiments, the determining the at least one recommended route includes: determining an estimated driving distance of each of the at least one possible driving route; for each of the at least one possible driving route, determining an estimated driving time based on the estimated speed and the estimated driving distance of each of the at least one possible driving route; and determining the at least one recommended route from the at least one possible driving route based on the estimated driving time of each possible driving route.

In some embodiments, the prediction model includes at least two layers: each layer includes at least one GAN or at least one RBM, and an output of a previous layer is an input of a next layer of the previous layer.

In some embodiments, the prediction model includes: a first layer including a GAN; a second layer including a RBM; and a third layer including a RBM.

According to still another aspect of the present disclosure, a non-transitory computer readable medium, comprising a first operation system and at least one set of instructions compatible with the first operation system for providing a travelling suggestion to a user terminal in an online on-demand service, wherein when executed by at least one processor of one or more electronic device, the at least one set of instructions directs the at least one processor to: receive the service request from a user terminal; obtain a prediction model combining at least one Generative Adversarial Networks (GAN) and at least one Restricted Boltzmann Machines (RBM); determine at least one recommended route for the user terminal based on the service request and the prediction model; generate electronic signals including the recommended route and a triggering code, wherein the triggering code is: in a format recognizable by a second operation system of the user terminal, and configured to render the second operation system of the user terminal to generate a presentation of the recommended route on an interface of the user terminal; and send the electronic signals to the at least one antenna to direct the antenna to send the electronic signals to the user terminal.

According to still another aspect of the present disclosure, a system configured to provide a travelling suggestion to an interface on a user terminal in an online on-demand transportation service, comprises: an acquisition module configured to receive a service request from a user terminal; a training module configured to obtain a prediction model combining at least one Generative Adversarial Networks (GAN) and at least one Restricted Boltzmann Machines (RBM); and a route determination module configured to determine at least one recommended route for the user terminal based on the service request and the prediction model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of a computing device according to some embodiments of the present disclosure;

FIG. 3 a schematic diagram illustrating exemplary hardware and/or software components of a mobile device according to some embodiments of the present disclosure;

FIG. 4A is a block diagram illustrating an exemplary processing engine according to some embodiments of the present disclosure;

FIG. 4B is a block diagram illustrating an exemplary route determination module according to some embodiments of the present disclosure;

FIG. 5 is a flowchart illustrating an exemplary process for providing a travelling suggestion according to some embodiments of the present disclosure;

FIG. 6 is a flowchart illustrating an exemplary process for obtaining a prediction model according to some embodiments of the present disclosure;

FIG. 7 is a diagram illustrating an exemplary hybrid model according to some embodiments of the present disclosure;

FIG. 8 is a flowchart illustrating an exemplary process for determine at least one commended route according to some embodiments of the present disclosure; and

FIG. 9 is a flowchart illustrating an exemplary process for determine at least one commended route according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to systems and methods for providing a travelling suggestion (e.g., a recommended route) to an interface on a user terminal in an online on-demand service. The systems and methods may obtain a prediction model by training a hybrid model based on training samples, wherein the prediction model may be a combination of at least one Generative Adversarial Networks (GAN) and at least one Restricted Boltzmann Machines (RBM). The systems and methods may receive a service request, including a departure location and a destination, from a user terminal. The systems and methods may determine at least one recommended route for the user terminal based on the service request and the prediction model. The recommended routes may guide users to travel with less congestions, which may improve user experiences and mitigate traffic congestions.

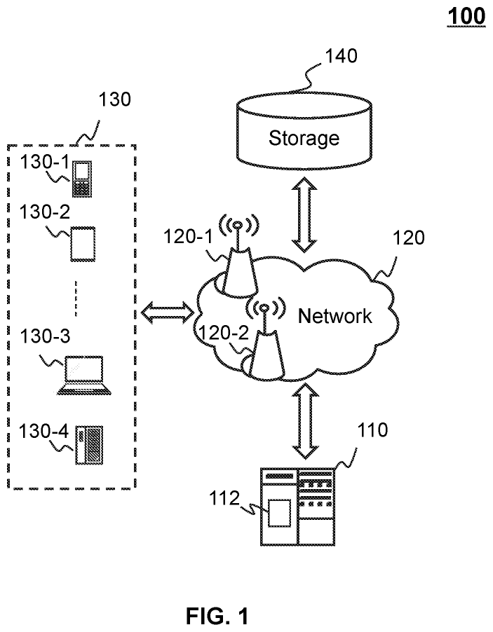

FIG. 1 is a schematic diagram of an exemplary on-demand service system 100 according to some embodiments of the present disclosure. For example, the on-demand service AI system 100 may be an online transportation service platform for transportation services such as taxi hailing, chauffeur services, delivery vehicles, carpool, bus service, driver hiring, shuttle services, and online navigation services. The on-demand service AI system 100 may be an online platform including a server 110, a network 120, a user terminal 130, and a storage 140. The server 110 may include a processing engine 112.

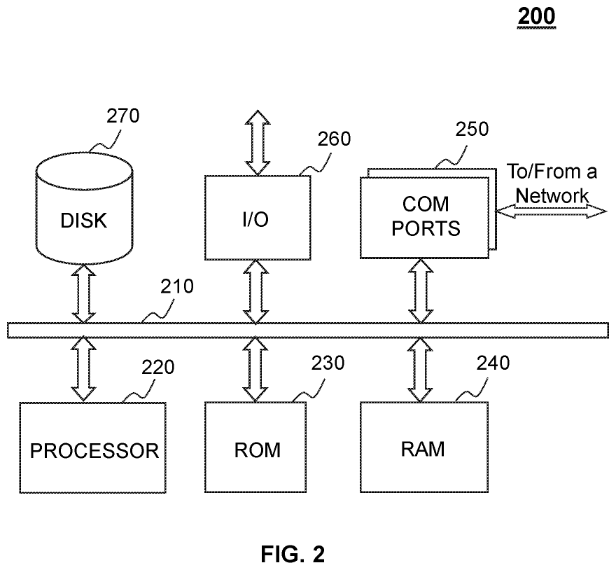

The server 110 may be configured to process information and/or data relating to the on-demand service. For example, the server 110 may train a hybrid model to obtain a prediction model based on training samples. In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the user terminal 130, and/or the storage 140 via the network 120. As another example, the server 110 may connect the user terminal 130, and/or the storage 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine at least one possible driving route based on the service request. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the on-demand service AI system 100 (e.g., the server 110, the user terminal 130, and the storage 140) may transmit information and/or data to other component(s) in the on-demand service AI system 100 via the network 120. For example, the server 110 may receive a service request from the user terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service AI system 100 may be connected to the network 120 to exchange data and/or information between them.

In some embodiments, the user terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a wearable device, a smart mobile device, a virtual reality device, an augmented reality device, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, built-in device in the motor vehicle 130-4 may include an onboard computer, an onboard television, etc. In some embodiments, the user terminal 130 may be a device with positioning technology for locating the position of the requestor and/or the user terminal 130.

The storage 140 may store data and/or instructions. In some embodiments, the storage 140 may store data obtained from the user terminal 130. In some embodiments, the storage 140 may store data and/or instructions that the server 110 may execute or use to perform exemplary methods described in the present disclosure. In some embodiments, the storage 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 140 may be connected to the network 120 to communicate with one or more components of the on-demand service AI system 100 (e.g., the server 110, the user terminal 130). One or more components in the on-demand service AI system 100 may access the data or instructions stored in the storage 140 via the network 120. In some embodiments, the storage 140 may be directly connected to or communicate with one or more components in the on-demand service AI system 100 (e.g., the server 110, the user terminal 130). In some embodiments, the storage 140 may be part of the server 110.

In some embodiments, one or more components of the on-demand service AI system 100 (e.g., the server 110, the user terminal 130) may access the storage 140. In some embodiments, one or more components of the on-demand service AI system 100 may read and/or modify information relating to the requester, and/or the public when one or more conditions are met. For example, the server 110 may read and/or modify one or more users' information after a service.

In some embodiments, the on-demand system 100 may further include at least one information exchange port (e.g., at least one antenna). The at least one antenna may be configured to send and/or receive information and/or data relating to the service request (e.g., in form of electronic signals) between any electronic devices in the on-demand system 100. For example, the at least one antenna may receive a service request (e.g., in form of electronic signals) from the user terminal 130 through wireless communications between the at least one antenna and the user terminal 130. The at least one antenna may then send the service request (e.g., in form of electronic signals) to the server 110 through wireless communications. As another example, the at least one antenna may receive recommended route (e.g., in form of electronic signals) from the server 110, and send the recommended route (e.g., in form of electronic signals) to the user terminal 130.

It should be noted that the application scenario illustrated in FIG. 1 is only provided for illustration purposes, and not intended to limit the scope of the present disclosure. For example, the on-demand system 100 may be used as a navigation system.

FIG. 2 is a schematic diagram illustrating exemplary hardware and software components of a computing device 200 on which the server 110, and/or the user terminal 130 may be implemented according to some embodiments of the present disclosure. For example, the processing engine 112 may be implemented on the computing device 200 and configured to perform functions of the processing engine 112 disclosed in this disclosure.

The computing device 200 may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. The processing circuits may also generate electronic signals including the conclusion or the result (e.g., the recommended route) and a triggering code. In some embodiments, the trigger code may be in a format recognizable by an operation system of an electronic device (e.g., the user terminal 130, the driver terminal 140, etc.) in the on-demand system 100. For example, the trigger code may include an instruction, a code, a mark, a symbol, or the like, or any combination thereof, that can activate certain functions and/or operations of a mobile phone or let the mobile phone execute a predetermined program(s). In some embodiments, the trigger code may be configured to render the operation system of the electronic device to generate a presentation of the conclusion or the result (e.g., the recommended route) on an interface of the electronic device. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The exemplary computing device may also include operation systems stored in the ROM 230, RAM 240, and/or other type of non-transitory storage medium to be executed by the processor 220. The program instructions may be compatible with the operation systems for providing the on-demand service. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus, operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

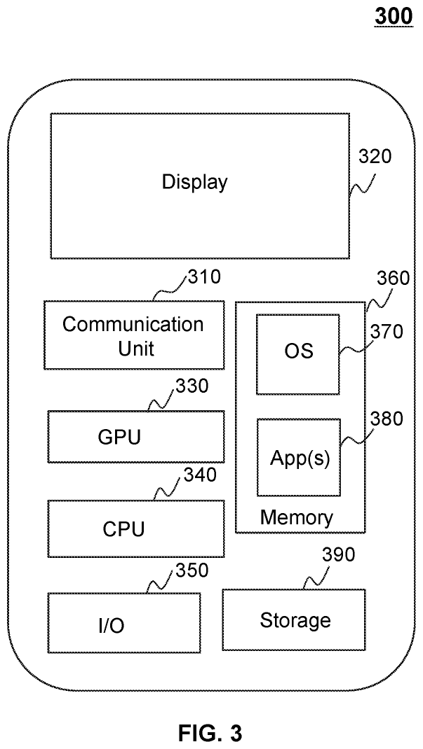

FIG. 3 is a schematic diagram illustrating exemplary hardware and/or software components of an exemplary mobile device 300 on which the user terminal 130 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™ Windows Phone™, etc.) and one or more applications 380 may be loaded into the memory 360 from the storage 390 in order to be executed by the CPU 340. The applications 380 may include a browser or any other suitable mobile apps for receiving and rendering information relating to an order for service or other information from the location-based service providing system on the mobile device 300. User interactions with the information stream may be achieved via the I/O devices 350 and provided to the processing engine 112 and/or other components of the system 100 via the network 120.

To implement various modules, units, and their functionalities described in the present disclosure, computer hardware platforms may be used as the hardware platform(s) for one or more of the elements described herein (e.g., the on-demand service AI system 100, and/or other components of the on-demand service AI system 100 described with respect to FIGS. 1-8). The hardware elements, operating systems and programming languages of such computers are conventional in nature, and it is presumed that those skilled in the art are adequately familiar therewith to adapt those technologies to the management of the supply of service as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

One of ordinary skill in the art would understand that when an element of the on-demand service AI system 100 performs, the element may perform through electrical signals and/or electromagnetic signals. For example, when a user terminal 130 processes a task, such as making a determination, the user terminal 130 may operate logic circuits in its processor to process such task. When the user terminal 130 sends out a service request to the server 110, a processor of the service user terminal 130 may generate electrical signals encoding the service request. The processor of the user terminal 130 may then send the electrical signals to an output port. If the user terminal 130 communicates with the server 110 via a wired network, the output port may be physically connected to a cable, which may further transmit the electrical signals to an input port of the server 110. If the user terminal 130 communicates with the server 110 via a wireless network, the output port of the user terminal 130 may be one or more antennas, which may convert the electrical signals to electromagnetic signals. Within an electronic device, such as the user terminal 130, and/or the server 110, when a processor thereof processes an instruction, sends out an instruction, and/or performs an action, the instruction and/or action is conducted via electrical signals. For example, when the processor retrieves or saves data from a storage medium (e.g., the storage 140), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

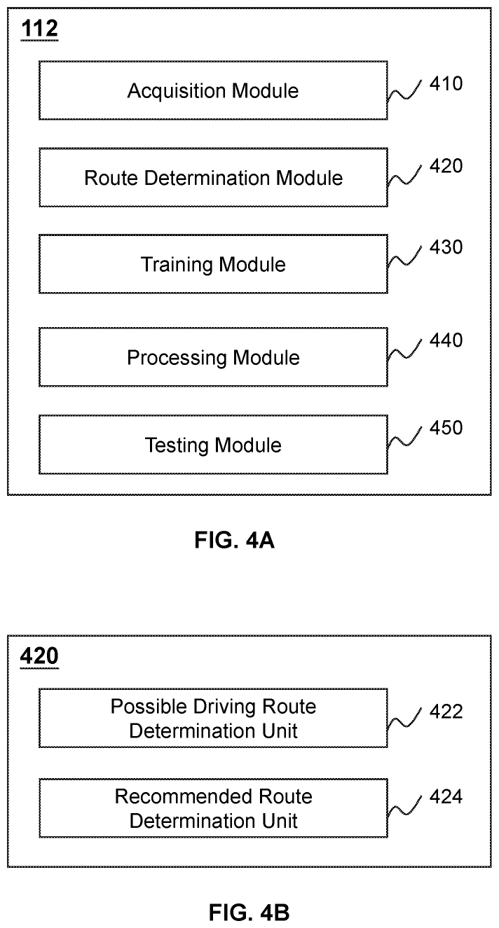

FIG. 4A is a block diagram illustrating an exemplary processing engine 112 according to some embodiments of the present disclosure. FIG. 4B is a block diagram illustrating an exemplary route determination module according to some embodiments of the present disclosure.

As illustrated in FIG. 4A, the processing engine 112 may include an acquisition module 410, a route determination module 420, a training module 430, a processing module 440, and a testing module 450. As illustrated in FIG. 4B, the route determination module 420 may include a possible driving route determination unit 422 and a recommended route determination unit 424.

The acquisition module 410 may be configured to obtain a service request from a user terminal 130.

The route determination module 420 may be configured to determine at least one recommended route for the user terminal. In some embodiments, the route determination module 420 may determine the at least one recommended route based on the service request and the prediction model. For example, route determination module 420 may first determine at least one possible driving route based on the service request. In particular, the at least one possible driving route, may be determined by the possible driving route determination unit 422. The route determination module 420 may be configured to determine an estimated driving speed based on the prediction model and at least one feature set associated with each possible driving route, and determine at least one recommended route from the at least one possible driving route based on the estimated driving speed of each possible driving route. For example, the route determination module 420 may determine an estimated driving speed associated with each possible driving route, determine an estimated driving distance of each of the at least one possible driving route, and for each of the at least one possible driving route, determine an estimated driving time based on the estimated speed and the estimated driving distance of each possible driving route, and determine the at least one recommended route from the at least one possible driving route based on the estimated driving time of each possible driving route. In particular, the estimated driving speed, the estimated driving distance, and the estimated driving time of each possible driving route may be determined by the recommended route determination unit 424.

The training module 430 may be configured to obtain a prediction model. For example, the training module 430 may obtain training samples including road information associated with a plurality of roads; obtain at least one feature set from the training samples; train a hybrid model to obtain the prediction model based on the training samples and the at least one feature set.

The processing module 440 may be configured to process the recommended route. For example, the processing module 440 may generate electronic signals including the recommended route and a triggering code after determining the recommended route. As another example, the processing module 440 may send the electronic signals to the at least one information exchange port to direct the at least one information exchange port to send the electronic signals to the user terminal 130.

The testing module 450 may be configured to test the prediction model. For example, the testing module 450 may obtain a testing sample, and determine an accuracy rate of the prediction model based on the testing sample. As another example, the testing module 450 may determine whether the accuracy rate is greater than an accuracy rate threshold to determine whether to re-train the prediction model and/or revise the parameters of the prediction model.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the training module 430 and the testing module 450 may be combined as a single module which may both train the prediction model and test the prediction model. As another example, the processing engine 112 may include a storage module (not shown) used to store data and/or information of the prediction model and/or recommended route.

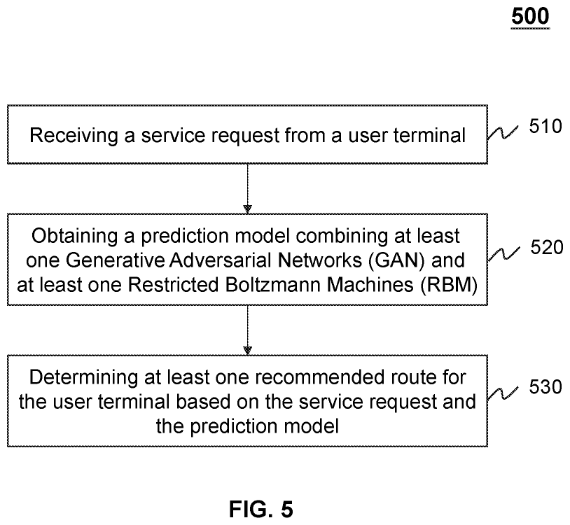

FIG. 5 is a flowchart illustrating an exemplary process for providing a travelling suggestion according to some embodiments of the present disclosure. The process 500 may be executed by the on-demand service AI system 100. For example, the process 500 may be implemented as a set of instructions (e.g., an application) stored in the storage ROM 230 or RAM 240. The processor 220 may execute the set of instructions, and when executing the instructions, it may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5 and described below is not intended to be limiting.

In process 510, the interface circuits of the processing engine 112 may access a storage medium (e.g., the ROM 230, the RAM 240) to load structured data of a set of instructions for providing a travelling suggestion. The processing engine 112 (e.g., the processing circuits of the processing engine 112) (e.g., the acquisition module 410) may provide a travelling suggestion (e.g., provide at least one recommended route) by executing the set of instructions.

In process 510, the processing engine 112 (e.g., the interface circuits, or the acquisition module 410) may also receive or obtain a service request from a user terminal 130. In some embodiments, the service request may include or may be a navigation service request, a transportation service request, a carpooling service request, a taxi calling service request, or the like, or any combination thereof. The service request may include a departure time, a departure location, a destination, a vehicle type, a license plate number of the vehicle, or the like, or any combination thereof. The vehicle type may include a sedan car, saloon car, a van, a bus, a truck, a limousine, a driverless vehicle, a motorcycle, a bicycle, or the like, or any combination thereof.

In some embodiments, a service requester (e.g., a passenger, a driver, and/or a user) may send and/or transmit the service request to the processing engine 112 through the user terminal 130. In particular, the service request may be transmitted via the network 120. The service requester may be a driver or a passenger of the vehicle. In some embodiments, when the service requester inputs information associated with the service request (e.g., the departure location and/or the destination etc.) on the interface of the user terminal, the user terminal may automatically send the service request to the processing engine 112. Alternatively or additionally, the user terminal may send the service request to the processing engine 112 only when the service requester permits the user terminal to do so (e.g., by pressing a transmitting button on the user terminal).

In process 520, the processing engine 112 (e.g., the processing circuits of the processing engine 112) (e.g., the training module 430) may obtain a prediction model combining at least one Generative Adversarial Networks (GAN) and at least one Restricted Boltzmann Machines (RBM). The prediction model may be used to predict the traffic condition of at least one route associated with the service request and provide a travelling suggestion (e.g., a recommended route) to the user terminal.

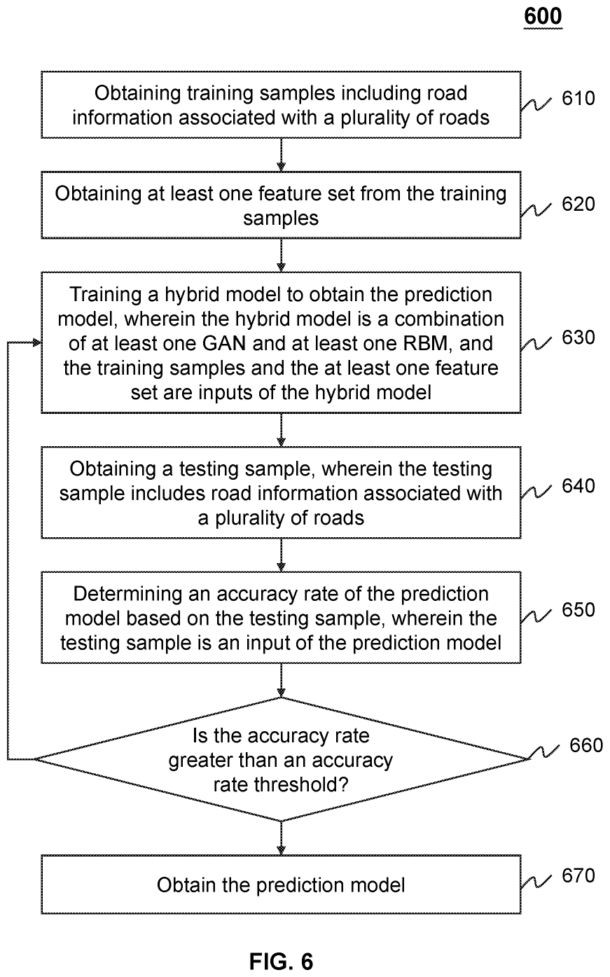

The GAN is a class of artificial intelligence algorithms used in unsupervised machine learning, implemented by a system of two neural networks contesting with each other in a zero-sum game framework. The RBM is a generative stochastic artificial neural network that can learn a probability distribution over its set of inputs. In some embodiments, the prediction model may include m layers of GAN, and n layers of RBM. Each of the m and n may be an integer which is larger than or equal to 1. For example, when m=n=1, the prediction model may include one layer of GAN and one layer of RBM. As another example, when m=1, and n=2, the prediction model may include one layer of GAN and two layers of RBM. In this case, the prediction model may include a first layer including a GAN, a second layer including a RBM, and a third layer including a RBM. More descriptions regarding the prediction model may be found elsewhere in the present disclosure (e.g., FIG. 6 and the descriptions thereof).

In process 530, the processing engine 112 (e.g., the processing circuits of the processing engine 112) (e.g., the route determination module 420) may determine at least one recommended route for the user terminal based on the service request and the prediction model. In particular, the at least one recommended route may be determined by the possible driving route determination unit 422 and/or the recommended route determination unit 424.

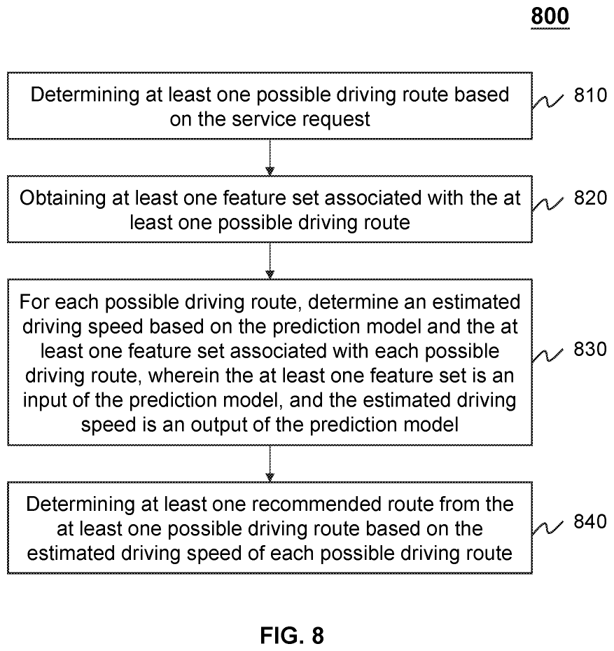

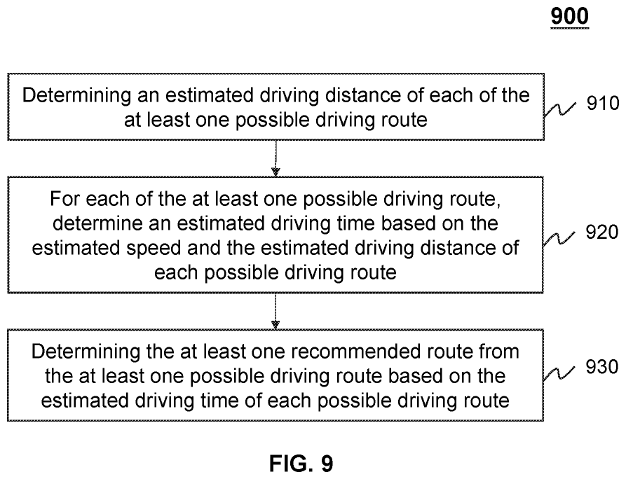

In some embodiments, one of the at least one recommended route may be the fastest driving route (e.g., a driving route allowing the fastest driving speed) among several candidate driving routes or all possible driving routes from the departure location to the destination of the service request. For example, one of the recommended route may have the best traffic condition, thereby having the highest estimated driving speed. As another example, one of the at least one recommended route may cost the shortest estimated driving time. More descriptions regarding the determination of the at least one recommended route may be found elsewhere in the present disclosure (e.g., FIG. 8, FIG. 9 and the descriptions thereof).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a transmission step) may be added elsewhere in the exemplary process 500. In the transmission step, the processing engine 112 may transmit the at least one recommended route to the user terminal, and the at least one recommended route may be shown on the interface of the user terminal 130. As another example, one or more steps may be added elsewhere in the exemplary process 500. The processing engine 112 (e.g., the processing circuits of the processing engine 112) (e.g., the processing module 440) may generate electronic signals including the recommended route and a triggering code after determining the recommended route, and send the electronic signals to the at least one information exchange port to direct the at least one information exchange port to send the electronic signals to the user terminal 130. In some embodiments, the triggering code may include and/or be a format recognizable by the user terminal 130 (e.g., by an operation system of the user terminal). For example, the trigger code may include an instruction, a code, a mark, a symbol, or the like, or any combination thereof, that can motivate the user terminal 130 or let the user terminal 130 execute any program. In some embodiments, the trigger code may be configured to render the operation system of the user terminal 130 to generate a presentation of the conclusion or the result (e.g., the recommended route) on an interface of the user terminal 130.

FIG. 6 is a flowchart illustrating an exemplary process for obtaining a prediction model according to some embodiments of the present disclosure. The process 600 may be executed by the on-demand service AI system 100. For example, the process 600 may be implemented as a set of instructions (e.g., an application) stored in the storage ROM 230 or RAM 240. The processor 220 may execute the set of instructions, and when executing the instructions, it may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process as illustrated in FIG. 6 and described below is not intended to be limiting. In some embodiments, step 520 in process 500 may be performed based on process 600.

In process 610, the processing engine 112 (e.g., the processing circuits of the processing engine 112) (e.g., the training module 430) may obtain training samples including road information associated with a plurality of roads. Each of the training samples may include road information associated with a road. For example, the road information may include information such as traffic conditions of the road in certain time period and a feature set (as described in step 620) of the road. The traffic conditions may include the number of a plurality of vehicles on the road during the time period, a vehicle density of the road during the time period, a driving speed of each of the plurality of vehicles on the road during the time period, an average driving speed of the plurality of vehicles on the road during the time period, or the like, or any combination thereof. In some embodiments, the time period may be any period of time predetermined by the on-demand system 100. For example, the time period may be a period from 2 hours (or 0.5, 1, 3, 6, 12 hours) ago to a current time point.

In some embodiments, the processing engine 112 may obtain the training samples from one or more information sources that provide information, such as road conditions, weather conditions, traffic information, event information, news information, or the like, or any combination thereof. The information source may include a map, a road monitoring system, a weather station, a TV station, an office, or the like, or any combination thereof. In some embodiments, the processing engine 112 may obtain the training samples from the storage device 140 and/or any storage (e.g., the ROM 230, the RAM 240, etc.) of the computing device 200, which stores historical real-time driving information (e.g., historical real-time GPS data, historical real-time driving speeds, etc.), and/or historical statistic driving information (e.g., vehicle densities of the a road during a time period, average driving speed of a plurality of vehicles on the road during the time period, etc.).

In process 620, the processing engine 112 (e.g., the processing circuits of the processing engine 112) (e.g., the training module 430) may obtain at least one feature set from the training samples. In some embodiments, the at least one feature set may include a plurality of basic features, a plurality of real-time features, a plurality of historical features, or the like, or any combination thereof.

The basic feature may refer to an inherent characteristic of a road associated with the training samples. For example, the basic feature may include a length of the road, a width of the road, a road sign in the road, a gradient of the road, a speed limit, traffic light information, or the like, or any combination thereof. The real-time feature may refer to a real-time event that is happened associated with the road in a certain time period. For example, the real-time feature may include a weather condition, an accident, a time period (e.g., traffic hours, non-traffic hours, etc.), or the like, or any combination thereof. The historical feature may refer to a characteristic of the road in a past time period. For example, the historical feature may include the number of a plurality of vehicles on the road during the past time period, a driving speed of each of the plurality of vehicles on the road during the past time period, an average driving speed of the plurality of vehicles on the road during the past time period, or the like, or any combination thereof.

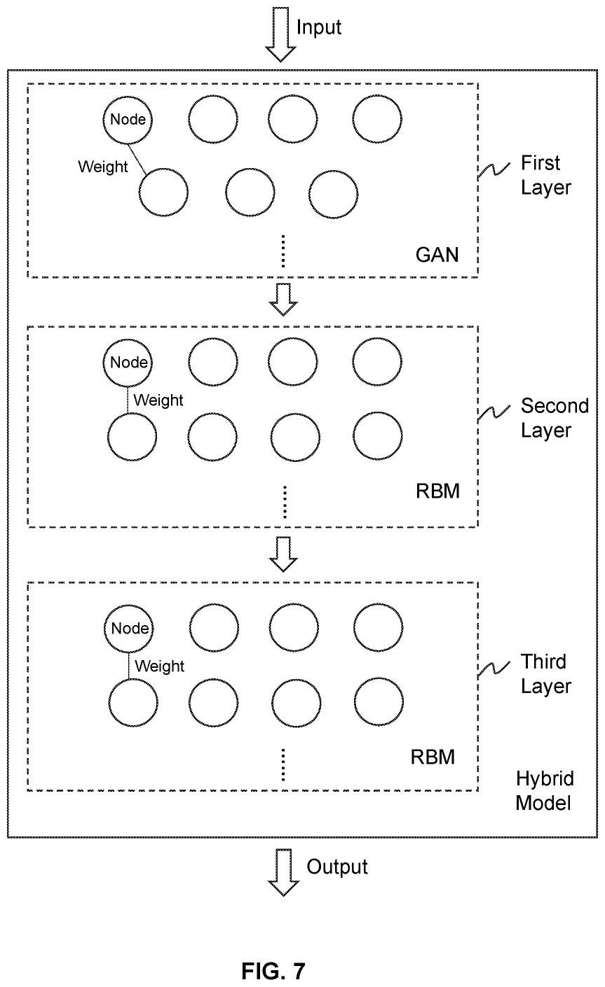

In process 630, the processing engine 112 (e.g., the processing circuits of the processing engine 112) (e.g., the training module 430) may train a hybrid model to obtain the prediction model based on the training samples and the at least one feature set. In some embodiments, the hybrid model may refer to a combination of more than one model. For example, the hybrid model may be a combination of at least one GAN and at least one RBM. For example, the hybrid model may include one more GANs stacked on one or more RBM or vice versa, or the one or more GANs may be orderly or randomly sandwiched with the one or more RBM. In some embodiments, the hybrid model may include m layers of GAN and n layers of RBM. Each of the m and n may be an integer which is larger than or equal to 1. In some embodiments, the m and n may be predetermined. In some embodiments, the m and/or n may be changed during the training process of the hybrid model. For example, when m=n=1, the hybrid model may include a layer of GAN and a layer of RBM. As another example, when m=1 and n=2, the hybrid model may include one layer of GAN and two layers of RBM. In this case, the hybrid model may include a first layer including a GAN, a second layer including a RBM, and a third layer including a RBM. FIG. 7 is a diagram illustrating an exemplary hybrid model according to some embodiments of the present disclosure. As shown in FIG. 7, the hybrid model may include three layers, the first layer is a GAN, the second layer is a RBM, and the third layer is a RBM. Each layer may include a plurality of nodes, and a plurality of weights. Each weight between two relevant nodes may be determined and/or optimized during the training process of the hybrid model. An output of a previous layer may be an input of a next layer of the previous layer. It should be noted that FIG. 7 only illustrates three layers, and the nodes and weights shown are only illustrated for purpose. The hybrid model may include any amount of layers, and each layer may include any amount of nodes and weights.

In some embodiments, the training samples and the at least one feature set may be the inputs of the hybrid model. For example, when the hybrid model includes a first layer including a GAN, a second layer including a RBM, and a third layer including a RBM, the training samples and the at least one feature set may be inputted into the first layer (i.e., the GAN). In this case, the GAN may be trained based on the training samples and the at least one feature set. For example, the processing engine 112 may first input the training samples and the at least one feature set (e.g., in the form of vectors) into the GAN. The historical road conditions (e.g., historical real driving speed during a period of time, etc.) may be the label (or the excepted output) to train the GAN, and parameters (e.g., each weight corresponding to each node of the GAN, etc.) of the GAN may be determined and/or optimized during the training process. The output of the GAN may include a predicted traffic condition of a road (e.g., a predicted speed) under a situation including the corresponding basic features, the real-time features and/or the historical features in each of the training samples. The training of the GAN may not be accomplished until the predicted traffic condition of a road associated with each of the training samples are the same or substantially the same as the traffic condition of the road in the certain time period. For example, when a difference between a predicted average driving speed and the average driving speed of the plurality of vehicles on the road during the certain time period is less than a threshold (e.g., 10%, 20%), the training of the GAN may be accomplished. When the training of the GAN is accomplished, the output of the GAN may be inputted into the second layer (i.e., the RBM). In some embodiments, the inputs of the second layer (i.e., the RBM) may include the output of the first layer (e.g., the predicted traffic condition of the GAN) and the at least one feature set. The RBM may be trained based on the output of the first layer (e.g., the predicted traffic condition output from the GAN) and the at least one feature set (e.g., in form of vectors). The historical road conditions (e.g., historical real driving speed during a period of time, etc.) may be the label (or the excepted output) to train the second layer of RBM, and parameters (e.g., each weight corresponding to each node of the second layer of RBM, etc.) of the second layer of RBM may be determined and/or optimized during the training process. The training process of the second layer of RBM may be similar to the training process of the GAN. Similarly, the inputs of the third layer (i.e., the RBM), including the output of the second layer (e.g., the predicted traffic condition output from the second layer of RBM, such as a predicted speed under the corresponding basic features, the corresponding real-time features and/or the corresponding historical features, etc.) and the at least one feature set, may be used to train the third layer of RBM. The historical road conditions (e.g., historical real driving speed during a period of time, etc.) may be the label (or the excepted output) to train the third layer of RBM, and parameters (e.g., each weight corresponding to each node of the third layer of RBM, etc.) of the third layer of RBM may be determined and/or optimized during the training process.

In some embodiments, the training of each layer of the hybrid model may continue until the model of each layer is converged. For example, when the parameters of each layer (e.g., the corresponding weights of each model, such as the first layer of GAN, the second layer of RBM, and the second layer of RBM) are no longer changed during several iterations, the training of the hybrid model may be stopped. When the trainings of the three layers are accomplished, the training of the hybrid model may be accomplished. The processing engine 112 may regard the trained hybrid model as the prediction model. The prediction model may refer to a method and/or algorithm that may predict a traffic condition of a road. For example, the processing engine 112 may input a plurality of vectors including basic features of the road, real-time features, and historical features of the road, and the prediction model may output a predicted speed of vehicle that a vehicle may drive on the road.

In process 640, the processing engine 112 (e.g., the processing circuits of the processing engine 112) (e.g., the testing module 450) may obtain a testing sample. The testing sample may be similar to, or the same as the training samples as descripted in step 610. In some embodiments, the testing sample and the training sample may be interchangeable.

In process 650, the processing engine 112 (e.g., the processing circuits of the processing engine 112) (e.g., the testing module 450) may determine an accuracy rate of the prediction model based on the testing sample.

In some embodiments, the processing engine 112 may input the testing sample (e.g., a feature set associated with the testing sample) into the prediction model and obtain a predicted traffic condition of a road associated with the testing sample, which is the output of the prediction model. The processing engine 112 may determine a difference between the predicted traffic condition (e.g., a predicted average driving speed) and the traffic condition (e.g., an average driving speed) of the road associated with the testing sample in a time period. In this case, the processing engine 112 may determine the accuracy rate of the predication model based on the difference. For example, if a predicted average driving speed is 80 km/h, and the average driving speed is 100 km/h, the difference between the predicted traffic condition and the traffic condition may be determined as 20%. Consequently, the processing engine 112 may determine that the accuracy rate of the predication model is 1-20%, which equals 80%.

In some embodiments, the processing engine 112 may obtain a plurality of testing samples, and determine a plurality of accuracy rates associated with the plurality of testing samples. The processing engine 112 may determine the accuracy rate of the prediction model according to a mean absolute percentage error (MAPE) algorithm. For example, the accuracy rate of the prediction may be determined as an average value of the plurality of accuracy rates.

In process 660, the processing engine 112 (e.g., the processing circuits of the processing engine 112) (e.g., the testing module 450) may determine whether the accuracy rate is greater than an accuracy rate threshold. In some embodiments, the accuracy rate threshold may be predetermined. For example, the accuracy rate threshold may be predetermined by the processing engine 112 based on different application scenarios (e.g., different roads, different weather conditions, etc.). In some embodiments, the accuracy rate threshold may vary between 70% and 95%. For example, the accuracy rate may be 70%, 80%, 90%, 95%, etc.

In some embodiments, if the accuracy rate is greater than the accuracy rate threshold, the process 600 may proceed to 670. If the accuracy rate is less than or equal to the accuracy rate threshold, the process 600 may proceed to 630 to revise the prediction model (e.g., re-train a hybrid model to obtain a new prediction model, revise the parameters such as weights of one or more layers of the hybrid model, etc.).

In process 670, the processing engine 112 (e.g., the processing circuits of the processing engine 112) may obtain the prediction model. In some embodiments, the prediction model may only be used for roads associated with the training samples and/or the testing sample. In some embodiments, the prediction model may be used for all of roads in a region (e.g., a city, a province, a country).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, all of the samples, including the training samples and the testing sample, may be used to train the hybrid model to obtain the prediction model. In this situation, steps 640-670 may be omitted. As another example, a road may be divided into several road sections. The hybrid model may be trained based on training samples including road information associated with a plurality of road sections. As still another example, the processing engine 112 may input at least one test sample into each layer to determine an accuracy rate of each layer (e.g., the first layer of GAN, the second layer of RBM, the third layer of RBM). The output of the last layer may be input into the next layer only when the accuracy rate of the previous layer is greater than an accuracy rate threshold corresponding to the previous layer. The training process may be accomplished when the accuracy rate of the last layer is greater than an accuracy rate threshold corresponding to the last layer. In some embodiments, the accuracy rate threshold corresponding to each layer may be predetermined by the processing engine 112. The accuracy rate threshold of different layers may be same or different.

FIG. 8 is a flowchart illustrating an exemplary process for determine at least one commended route according to some embodiments of the present disclosure. The process 800 may be executed by the on-demand service AI system 100. For example, the process 800 may be implemented as a set of instructions (e.g., an application) stored in the storage ROM 230 or RAM 240. The processor 220 may execute the set of instructions, and when executing the instructions, it may be configured to perform the process 800. The operations of the illustrated process presented below are intended to be illustrative. In some embodiments, the process 800 may be accomplished with one or more additional operations not described and/or without one or more of the operations discussed. Additionally, the order in which the operations of the process as illustrated in FIG. 8 and described below is not intended to be limiting. In some embodiments, step 530 in process 500 may be performed based on process 800.

In process 810, the processing engine 112 (e.g., the processing circuits of the processing engine 112) (e.g., the route determination module 420 or the possible driving route determination unit 422) may determine at least one possible driving route based on the service request.

In some embodiments, the processing engine 112 may determine the at least one possible driving route based on the departure location and the destination associated with the service request. Each of the at least one possible driving route may be a driving route from the departure location to the destination. In some embodiments, the processing engine 112 may determine the at least one possible driving route according to a map (e.g., a traffic map). In some embodiments, the processing engine 112 may determine the at least one possible driving route based on a route planning method. A target of the route planning method may be minimizing the length of the route. In some embodiments, each of the at least one possible driving route may include one or more road sections. Each of the one or more road sections may be part of or the entire length of a road.

In some embodiments, the processing engine 112 (e.g., the processing circuits of the processing engine 112) (e.g., the route determination module 420, or the possible driving route determination unit 422) may determine the at least one possible driving route based on the departure time, the vehicle type, the license plate number of the vehicle, or the like, or any combination thereof. For example, a truck may not be limited to travel in a road section in a traffic hours (e.g., 8:00-10:00). As another example, if a license plate number of a car belongs to city A, the car may not be limited to travel in a road section in a traffic hours in city B.

In process 820, the processing engine 112 (e.g., the processing circuits of the processing engine 112) (e.g., the route determination module 420 or the recommended route determination unit 424) may obtain at least one feature set associated with the at least one possible driving route. In some embodiments, the at least one feature set may include a plurality of basic features, a plurality of real-time features, a plurality of historical features, or the like, or any combination thereof.

The basic feature may refer to an inherent characteristic of a road section of the at least one possible driving route. For example, the basic feature may include a length of the road section, a width of the road section, a road sign in the road section, a gradient of the road section, a speed limit, traffic light information, or the like, or any combination thereof. The real-time feature may refer to a real-time event that is happened associated with the road section in a certain time period. For example, the real-time feature may include a weather condition, an accident, a time period condition (e.g., traffic hours and/or non-traffic hours, etc.), or the like, or any combination thereof. The historical feature may refer to a characteristic of the road section in a past time period. For example, the historical feature may include the number of a plurality of vehicles on the road section during the past time period, a driving speed of each of the plurality of vehicles on the road section during the past time period, an average driving speed of the plurality of vehicles on the road section during the past time period, or the like, or any combination thereof.

In process 830, for each possible driving route, the processing engine 112 (e.g., the processing circuits of the processing engine 112) (e.g., the route determination module 420, or the recommended route determination unit 424) may determine and/or calculate an estimated driving speed based on the prediction model and the at least one feature set associated with each possible driving route. The at least one feature set may be an input of the prediction model, and the estimated driving speed may be an output of the prediction model. In some embodiments, the estimated driving speed may be an estimated average driving speed of the whole route of each possible driving route.

In some embodiments, each possible driving route may include one or more road sections. The processing engine 112 may determine a predicted driving speed of each of the one or more road sections based on the prediction model and a feature set associated with each of the one or more road sections. For example, the processing engine 112 may input a feature set of each road section of the possible driving route into the prediction model to obtain an estimated driving speed of each road section. In this case, the processing engine 112 may determine the estimated driving speed of the possible driving route based on the predicted driving speed and the length of each of the one or more road sections. For example, the processing engine 112 may determine an estimated driving time of each of the one or more road sections based on the predicted driving speed and the length of each of the one or more road sections. For example, the processing engine 112 may divide the length of each road section by the predicted driving speed of each road section to obtain an estimated driving time of each road section, and adding each estimated driving time of each of the one or more road sections of the possible driving route to obtain the estimated driving time of the possible driving route. The processing engine 112 may determine a total length of the possible driving route by adding the length of each of the one or more road sections. Consequently, the processing engine 112 may divide the length of the possible driving route by the estimated driving time of the possible driving route to obtain the estimated driving speed of the possible driving route.

In process 840, the processing engine 112 (e.g., the processing circuits of the processing engine 112) (e.g., the route determination module 420, or the recommended route determination unit 424) may determine at least one recommended route from the at least one possible driving route based on the estimated driving speed of each possible driving route. In some embodiments, if there is only one possible driving route, the recommended route may be the possible driving route. In some embodiments, if there are two or more possible driving routes, the processing engine 112 may first obtain an estimated driving distance of each possible driving route, and calculate an estimated driving time of each possible driving route by dividing the estimated driving distance by the corresponding estimated driving speed of each possible driving route. The at least one recommended route may be a route having the shortest driving time among all of the possible driving routes. For example, if two possible driving routes are determined as recommended routes, the two possible driving routes may have the top two shortest estimated driving time among all of the possible driving routes. More descriptions regarding the determination of the at least one recommended route may be found elsewhere in the present disclosure (e.g., FIG. 9 and the descriptions thereof).

In some embodiments, the processing engine 112 may determine at least one recommended route from at least one possible driving route based on the estimated driving distance, the traffic conditions, or the like, or any combination thereof. For example, the processing engine 112 may determine an estimated driving distance based on the prediction model and the at least one feature set of each possible driving route, and select a route with the shortest estimated driving distance as a recommended route. As another example, the processing engine 112 may determine an traffic condition (e.g., a traffic congestion index, the number of traffic lights) based on the prediction model and the at least one feature set of each possible driving route, and select a route with the least congestion (or the least traffic lights) as a recommended route.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the at least one recommended route may be a combination of road sections associated with the possible driving routes. In this situation, the processing engine 112 may determine a predicted driving speed of each of the road sections associated with the possible driving routes, and determine the at least one recommended route based on the predicted driving speed of each of the road sections.

FIG. 9 is a flowchart illustrating an exemplary process for determine at least one commended route according to some embodiments of the present disclosure. The process 900 may be executed by the on-demand service AI system 100. For example, the process 900 may be implemented as a set of instructions (e.g., an application) stored in the storage ROM 230 or RAM 240. The processor 220 may execute the set of instructions, and when executing the instructions, it may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process as illustrated in FIG. 9 and described below is not intended to be limiting. In some embodiments, step 840 in process 800 may be performed based on process 900.

In process 910, the processing engine 112 (e.g., the processing circuits of the processing engine 112) (e.g., the route determination module 420, or the recommended route determination unit 424) may determine an estimated driving distance of each of the at least one possible driving route. In some embodiments, the estimated driving distance of a possible driving route may be equal to a length of the possible driving route. The length of the possible driving route may be equal to a sum of the one or more road sections of the possible driving route. In some embodiments, the processing engine 112 may obtain the length of each road section from an information source. For example, the processing engine 112 may obtain the length of each road section from mapping data of each road section in a map (e.g., a traffic map). As another example, the processing engine 112 may obtain the length of each road section from historical driving data of one or more historical drivers (e.g., the length of each road section may be equal to an average historical driving distance of the corresponding road section). In some embodiments, the processing engine 112 may determine the estimated driving distance of a possible driving route based on a length of each of road sections associated with the possible driving route.

In process 920, the processing engine 112 (e.g., the processing circuits of the processing engine 112) (e.g., the route determination module 420, or the recommended route determination unit 424) may determine an estimated driving time for each of the at least one possible driving route. The processing engine 112 may determine the estimated driving time based on the estimated speed and the estimated driving distance of each of the at least one possible driving route. For example, the estimated driving time may be determined by dividing the estimated driving distance by the estimated speed.

In process 930, the processing engine 112 (e.g., the processing circuits of the processing engine 112) (e.g., the route determination module 420, or the recommended route determination unit 424) may determine the at least one recommended route from the at least one possible driving route based on the estimated driving time of each possible driving route. In some embodiments, the at least one recommended route may be a route having the shortest estimated driving time among all of the possible driving routes. In some embodiments, if two possible driving routes are determined as recommended routes, the two possible driving routes may have the top two shortest estimated driving time among all of the possible driving routes.

In some embodiments, the at least one recommended route may be a combination of road sections associated with the possible driving routes. In this situation, the processing engine 112 may determine an estimated driving time of each of the road sections associated with the possible driving routes. The processing engine 112 may determine the at least one recommended route based on the estimated driving time of each of the road sections. For example, if an estimated driving time of a new route, combined by several road sections, is shorter than the estimated driving time of any of the possible driving routes, the new route may be designated as the recommended route.

In some embodiments, the processing engine 112 may determine a plurality of recommended routes based on different standards. For example, the plurality of recommended routes may include a route with the highest speed, a route with the shortest driving time, a route with shortest driving distance, a route with least road roll, or the like, or any combination thereof. In some embodiments, the processing engine 112 may transmit one or more recommended routes to the user terminal, and the one or more recommended route may be shown on the interface of the user terminal.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

1. A system of one or more electronic devices for using artificial intelligence to determine and display a driving instruction on an interface on a user terminal in an online on-demand transportation service, the system comprising:
at least one information exchange port to receive a service request from the user terminal through wireless communications between the at least one information exchange port and the user terminal;
at least one storage medium including a first operation system and a set of instructions compatible with the first operation system for providing a travelling suggestion to the user terminal in the online on-demand transportation service; and
at least one processor in communication with the storage medium, wherein when executing the first operation system and the set of instructions, the at least one processor is directed to:
receive the service request from the user terminal;
obtain a prediction model combining at least one Generative Adversarial Networks (GAN) and at least one Restricted Boltzmann Machines (RBM);
determine at least one recommended route for the user terminal based on the service request and the prediction model;
generate electronic signals including the recommended route and a triggering code, wherein the triggering code is:
in a format recognizable by a second operation system of the user terminal, and
configured to render the second operation system of the user terminal to generate a presentation of the recommended route on an interface of the user terminal; and
send the electronic signals to the at least one information exchange port to direct the at least one information exchange port to send the electronic signals to the user terminal.

2. The system of claim 1, wherein to obtain the prediction model, the at least one processor is further directed to:
obtain training samples including road information associated with a plurality of roads;
obtain at least one feature set from the training samples; and
obtain the prediction model by training a hybrid model, wherein the hybrid model is a combination of at least one GAN and at least one RBM, and the training samples and the at least one feature set are inputs of the hybrid model.

3. The system of claim 2, wherein the at least one feature set includes a plurality of basic features, a plurality of real-time features, and a plurality of historical features.

4. The system of claim 2, wherein the at least one processor is further directed to:
obtain a testing sample, wherein the testing sample includes road information associated with a plurality of roads;
determine an accuracy rate of the prediction model based on the testing sample, wherein the testing sample is an input of the prediction model;
determine that the accuracy rate is greater than an accuracy rate threshold; and
obtain the prediction model.

5. The system of claim 4, wherein the at least one processor is further directed to:
in response to determining that the accuracy rate is not greater than the accuracy rate threshold; and
revise the prediction model.

6. The system of claim 1, wherein to determine the at least one recommended route, the at least one processor is further directed to:
determine at least one possible driving route based on the service request;
obtain at least one feature set associated with the at least one possible driving route;
for each possible driving route of the at least one possible driving route, determine an estimated driving speed based on the prediction model and the at least one feature set associated with each possible driving route, wherein the at least one feature set is an input of the prediction model, and the estimated driving speed is an output of the prediction model; and
determine at least one recommended route from the at least one possible driving route based on the estimated driving speed of each possible driving route.

7. The system of claim 6, wherein to determine the at least one recommended route, the at least one processor is further directed to:
determine an estimated driving distance of each of the at least one possible driving route;
for each of the at least one possible driving route, determine an estimated driving time based on the estimated speed and the estimated driving distance of each of the at least one possible driving route; and
determine the at least one recommended route from the at least one possible driving route based on the estimated driving time of each possible driving route.

8. The system of claim 1, wherein the prediction model includes at least two layers: each layer of the at least two layers includes at least one GAN or at least one RBM, and an output of a previous layer is an input of a next layer of the previous layer.

9. The system of claim 1, wherein the prediction model includes:
a first layer including a GAN;
a second layer including a RBM; and
a third layer including a RBM.

10. A method for providing a travelling suggestion to an interface on a user terminal in an online on-demand transportation service, implemented on one or more electronic devices having at least one information exchange port to receive a service request from the user terminal through wireless communications between the at least one information exchange port and the user terminal, at least one computer-readable storage medium including a first operation system and a set of instructions compatible with the first operation system for providing a travelling suggestion to the user terminal in the online on-demand transportation service, and at least one processor in communication with the storage medium, the method comprising:
receiving a service request from the user terminal;
obtaining a prediction model combining at least one Generative Adversarial Networks (GAN) and at least one Restricted Boltzmann Machines (RBM);
determining at least one recommended route for the user terminal based on the service request and the prediction model;
generating electronic signals including the recommended route and a triggering code, wherein the triggering code is:
in a format recognizable by a second operation system of the user terminal, and
configured to render the second operation system of the user terminal to generate a presentation of the recommended route on an interface of the user terminal; and
sending the electronic signals to the at least one information exchange port to direct the at least one information exchange port to send the electronic signals to the user terminal.

11. The method of claim 10, wherein the obtaining the prediction model includes:
obtaining training samples including road information associated with a plurality of roads;
obtaining at least one feature set from the training samples; and
obtaining the prediction model by training a hybrid model, wherein the hybrid model is a combination of at least one GAN and at least one RBM, and the training samples and the at least one feature set are inputs of the hybrid model.

12. The method of claim 11, wherein the at least one feature set includes a plurality of basic features, a plurality of real-time features, and a plurality of historical features.

13. The method of claim 11 further comprising:
obtaining a testing sample, wherein the testing sample includes road information associated with a plurality of roads;
determining an accuracy rate of the prediction model based on the testing sample, wherein the testing sample is an input of the prediction model;
determining that the accuracy rate is greater than an accuracy rate threshold; and
obtaining the prediction model.

14. The method of claim 13 further comprising:
in response to determining that the accuracy rate is not greater than the accuracy rate threshold; and
revising the prediction model.

15. The method of claim 10, wherein the determining the at least one recommended route include:
determining at least one possible driving route based on the service request;
obtaining at least one feature set associated with the at least one possible driving route;
for each possible driving route of the at least one possible driving route, determining an estimated driving speed based on the prediction model and the at least one feature set associated with each possible driving route, wherein the at least one feature set is an input of the prediction model, and the estimated driving speed is an output of the prediction model; and
determining at least one recommended route from the at least one possible driving route based on the estimated driving speed of each possible driving route.

16. The method of claim 15, wherein the determining the at least one recommended route includes:
determining an estimated driving distance of each of the at least one possible driving route;
for each of the at least one possible driving route, determining an estimated driving time based on the estimated speed and the estimated driving distance of each of the at least one possible driving route; and
determining the at least one recommended route from the at least one possible driving route based on the estimated driving time of each possible driving route.

17. The method of claim 10, wherein the prediction model includes at least two layers: each layer of the at least two layers includes at least one GAN or at least one RBM, and an output of a previous layer is an input of a next layer of the previous layer.

18. The method of claim 10, wherein the prediction model includes:
a first layer including a GAN;
a second layer including a RBM; and
a third layer including a RBM.

19. A non-transitory computer readable medium, comprising a first operation system and at least one set of instructions compatible with the first operation system for providing a travelling suggestion to a user terminal in an online on-demand service, wherein when executed by at least one processor of one or more electronic device, the at least one set of instructions directs the at least one processor to:
receive the service request from the user terminal;
obtain a prediction model combining at least one Generative Adversarial Networks (GAN) and at least one Restricted Boltzmann Machines (RBM);
determine at least one recommended route for the user terminal based on the service request and the prediction model;
generate electronic signals including the recommended route and a triggering code, wherein the triggering code is:
in a format recognizable by a second operation system of the user terminal, and
configured to render the second operation system of the user terminal to generate a presentation of the recommended route on an interface of the user terminal; and
send the electronic signals to the at least one information exchange port to direct the at least one information exchange port to send the electronic signals to the user terminal.

20. (canceled)

21. The non-transitory computer readable medium of claim 19, wherein to obtain the prediction model, the at least one set of instructions further directs the at least one processor to:
obtain training samples including road information associated with a plurality of roads;
obtain at least one feature set from the training samples; and
obtain the prediction model by training a hybrid model, wherein the hybrid model is a combination of at least one GAN and at least one RBM, and the training samples and the at least one feature set are inputs of the hybrid model.
